(19) United States
(12) Patent Application Publication
(10) Pub. No.: US 2013/0144800 A1
(43) Pub. Date: Jun. 6, 2013

(54) Identifying Recommended Merchants

(71) Applicant: Thomas Mackenzie Fallows, San Francisco, CA (US)

(72) Inventor: Thomas Mackenzie Fallows, San Francisco, CA (US)

(73) Assignee: GOOGLE INC., Mountain View, CA (US)

(21) Appl. No.: 13/309,472

(22) Filed: Dec. 1, 2011

(51) Int. Cl. G06Q 30/00

(52) U.S. Cl. 705/341; 705/347

(57) ABSTRACT

Merchants are classified according to their reliability in shipping products when promised and ability to resolve complaints. A merchant trustworthiness evaluator (MTE) automatically gathers data from users about purchases online from a merchant, including an order identifier and an estimated ship date. In one embodiment, the MTE collects data from customers about their purchases through the use of a conversion pixel, transmitted to the customer by the merchant at the time of purchase. The MTE obtains shipment information from the merchant or shipment carrier once an order has been shipped. The MTE correlates the shipment data with the order data and compares for each order the estimated or promised and actual shipment dates. The MTE scores merchants and classifies each merchant based on its score. Merchant classifications can then be provided to prospective customers.

### BACKGROUND

1. Field

Described embodiments concern the evaluation of merchants involved in online commerce involving goods and services. In particular, described embodiments are directed to gathering and analyzing historical shipping and customer service data relating to online merchants for the purpose of evaluating the performance and reliability of those merchants.

2. Description of the Related Art

While online shopping has continued to be a popular form of commerce, customers and merchants alike are frustrated by its anonymity. Excellent, reliable merchants are unable to easily signal the high quality experience they provide to potential customers. Meanwhile, customers who are able to make price comparisons across online merchants struggle to ascertain merchant reliability and service levels at the same time.

Typical attempts to solve this problem focus on manual mechanisms of evaluating merchants. Often, buyers can rate merchants within online buying platforms, and the aggregate buyer feedback is displayed to customers. Some companies conduct independent evaluations and provide their editorial findings to members, or to the public. Alternatively, buyers can register complaints with organizations like the Better Business Bureau (BBB), and online buying platforms can monitor that data on behalf of customers.

### SUMMARY

Described embodiments enable classification of online merchants according to their reliability in shipping purchased products when promised; the number of days shipments take to arrive; the number of complaints they receive and how quickly they are resolved; the number of products they offer; and their return policies. A merchant trustworthiness evaluator (MTE) gathers data from users about purchases online from a merchant. In one embodiment, the MTE collects data from customers about their purchases through the use of a conversion pixel, transmitted to the customer by the merchant at the time of purchase. The information collected includes the merchant's estimated shipping date, the customer's Internet protocol (IP) address, and the order number. Additional information, such as specific items ordered, quantity, price, an estimated delivery date and estimated shipment weight may also be collected by the MTE.

The MTE additionally gathers data from online merchants. In one embodiment, merchants provide tracking information for shipped orders at regular intervals to the MTE. This information may include order numbers, their corresponding shipment tracking numbers, the carrier by which it was shipped, ship dates, and the zip codes to which orders are shipped. In some embodiments, the information is provided in batch by the merchant or the carrier, for example on a daily basis, while in other embodiments the information is provided to the MTE in real time when a product is tendered by the merchant to a shipment carrier.

The MTE correlates the order shipment information received from merchants or carriers with the purchase information received from users. In one embodiment, the MTE uses tracking numbers received from merchants to track shipment progress and automatically compares actual dates of shipment to the online merchant's stated estimated date of shipment.

In another embodiment, the MTE uses shipment data received from merchants or carriers and automatically compares the date of shipment with order data received from the customer. In another embodiment, the MTE uses tracking numbers received from merchants to track shipment progress and automatically compares the delivery date to the order date.

In one embodiment, the MTE performs an antifraud analysis to reduce opportunities for gamesmanship by merchants. Such techniques may include matching postal codes of package destinations to geolocations of IP addresses; comparing tracked package weights to known or estimated weights of the products being shipped in those packages; comparing package origin locations with known or estimated warehouse locations of the products being shipped in those packages; identifying mal-formed, duplicate, or invalid tracking numbers; and obtaining verification from customers of tracking numbers and actual shipment arrival dates.

The MTE evaluates the shipping performance of a merchant by scoring the merchant on historical shipping performance metrics. In various embodiments, these metrics include how frequently the merchant tendered orders to shipment carriers by the estimated or promised date and whether the shipment carrier delivered the order to the destination address on, before or after the estimated delivery date. The MTE passes these metrics through an evaluation engine to determine whether or not the MTE should be designated as trustworthy.

Merchant complaints are tracked each time a customer files a complaint with the MTE. Each merchant is measured to determine what portion of complaints are handled within a particular time window, e.g., 2 days. Merchants are then compared to average merchants to determine how they rank compared to that average. Merchants are also evaluated based on a number of complaints received relative to number of orders received, and that number is again evaluated against all merchants as a whole.

In various embodiments, a merchant's catalogue is tracked, and merchants are scored based on the size of their catalogue, i.e. a number of products in each of various categories that the merchant has available for sale.

In various embodiments, merchants' return policies are determined, and merchants with more favorable policies are given a higher rating than those with less favorable policies, as determined by the implementer.

Merchants determined to have particularly high scores in one or more tracked area can then be highlighted or otherwise identified to potential customers as part of their online shopping experience.

### BRIEF DESCRIPTION OF THE DRAWINGS

FIG. 1 is an illustration of a system for evaluating the trustworthiness of online merchants in accordance with one embodiment.

FIG. 2 is a flowchart illustrating a method for updating merchant profile data in accordance with one embodiment.

FIG. 3 is a flowchart illustrating a method for evaluating online merchants in accordance with one embodiment.

FIG. 4 is a screen shot illustrating a form for submitting a customer complaint in accordance with one embodiment.

FIG. 5 is a flowchart illustrating a method for complaint tracking in accordance with one embodiment.

FIG. 6 illustrates a merchant web site in accordance with one embodiment.

FIG. 7 illustrates an advertisement with merchant data in accordance with one embodiment.

FIG. 8 illustrates an advertisement with merchant data in accordance with one embodiment.

FIG. 9 illustrates an advertisement with merchant data in accordance with one embodiment.

FIG. 10 illustrates an advertisement with merchant data in accordance with one embodiment.

FIG. 11 illustrates an advertisement with merchant data in accordance with one embodiment.

FIG. 12 is a flowchart illustrating a method for displaying search results with merchant scores in accordance with one embodiment.

The figures depict embodiments for purposes of illustration only. One skilled in the art will readily recognize from the following discussion that alternative embodiments of the structures and methods illustrated herein may be employed without departing from the principles described herein.

### DETAILED DESCRIPTION

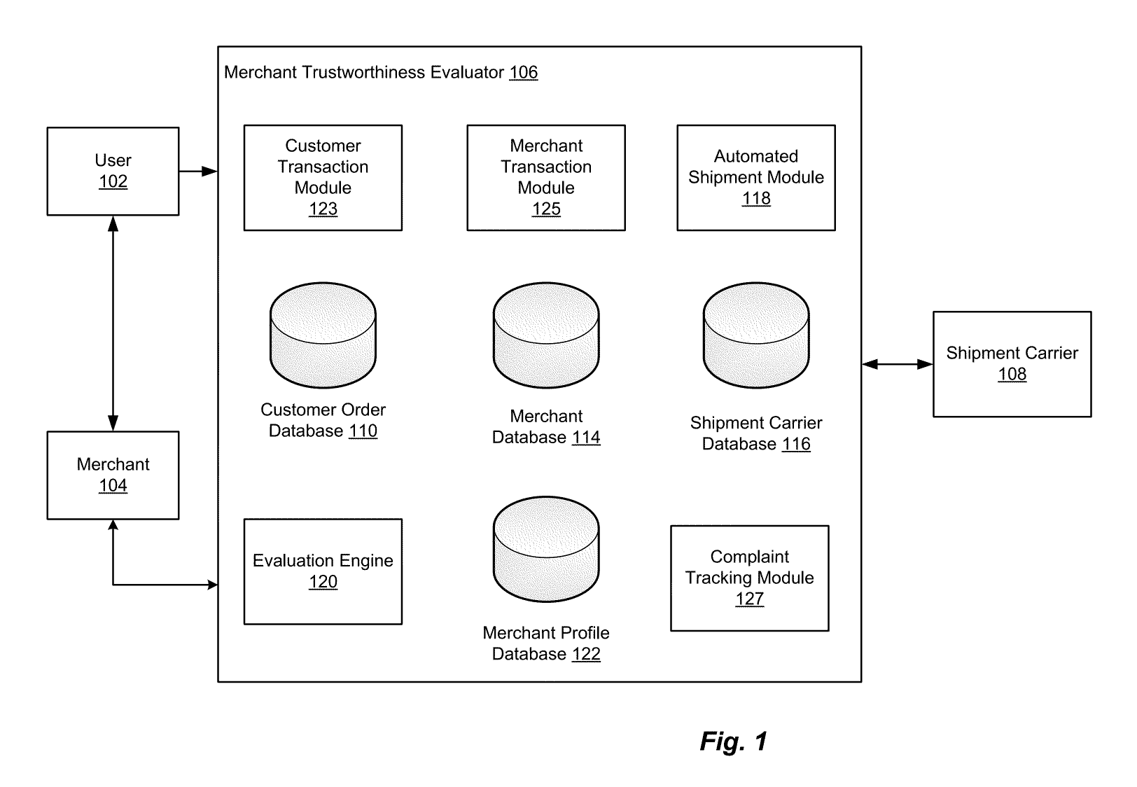

FIG. 1 is a block diagram of a merchant trustworthiness evaluator (MTE) system for evaluating the trustworthiness of online merchants in accordance with one embodiment. MTE 106 includes several databases and modules, including customer order database 110, merchant database 114, shipment carrier database 116, automated shipment module 118, evaluation engine 120, customer transaction module 123, merchant transaction module 125, complaint tracking module 127, and merchant profile database 122. Each of these is described further below. FIG. 1 also includes user computer 102, merchant 104, and shipment carrier 108. Although for clarity only one user computer 102, merchant 104, and shipment carrier 108 are illustrated, large numbers of each may be present in various embodiments.

User computer 102 is used by a customer who engages in an electronic commerce transaction, such as a purchase of a good or service. User computer 102 can be a laptop, desktop, cell phone, handheld device, thin or thick client device, video appliance, or any other appropriate computing platform, and transactions may be made using the Internet, cellular network, or any other suitable communications network. The user operating user computer 102 can be an individual, group of individuals, corporate entity, or automated computer system.

Merchant 104 is an individual, group of individuals, corporate entity, or automated computer system that provides goods or services for purchase through electronic commerce transactions, for example using a web site.

For ease of description, we refer generally to a “user”, and those of skill will recognize that this includes either the user (customer) herself, the user's computer system, or the combination of the two, as may be appropriate in context. We make similar use of the term “merchant”.

MTE 106 is an automated computer system administered by an individual, group of individuals, corporate entity, or automated computer system that collects order data and shipment data in connection with the purchase described above in order to evaluate merchants 104 and make a determination of their trustworthiness. One example of an MTE 106 provider is Google Inc., of Mountain View, Calif. Using the collected information, MTE 106 determines whether a merchant 104 should be designated as trustworthy by, for each of a plurality of orders from the merchant, comparing promised ship dates and shipment arrival times with actual ship dates and arrival times.

The interval between when a customer places an order with an online merchant and when the customer receives physical delivery of the order can be separated into two sub-intervals: first, a time between when the merchant receives the order and when the merchant ships the order; and second, a time between when the order is tendered to a shipper and when the shipper delivers the order to the specified shipping address.

In some embodiments, merchants are evaluated based on when they tender orders to the shipment carrier. In alternative embodiments, merchants are additionally evaluated based on when the shipment carrier delivers the order to the destination address. Although merchants may have less influence over the shipment once it has been tendered to the shipper, including the actual delivery date in the merchant evaluation prevents the merchant from escaping detection by, for example, choosing a different delivery option such as ground shipping, while charging the purchaser for a premium shipping option such as overnight air.

In various embodiments, merchants 104 display an estimated shipment date to users 102 as part of the product advertisement or transaction process. In some embodiments, a user is offered some measure of influence over the shipment date at purchase time, for example by paying an additional fee to the merchant for expedited processing; in other embodiments, the estimated shipment date is determined entirely by the merchant 104. Similarly, in some embodiments, users 102 are able to specify some combination of shipper and shipment method, e.g., overnight courier, standard mail, etc., that will impact the estimated time in transit of the shipment. In other embodiments, the merchant 104 determines the choice of carrier 108 and level of service. Ultimately, the user 102 is given an indication by the merchant 104 of either when the order is expected to be tendered to the shipper 108, when it is expected to be delivered to the user 102, or both.

In one embodiment, when user 102 completes a purchase transaction with merchant 104, user 102 communicates information about the transaction to customer transaction module 123 of MTE 106. In one embodiment, this information includes the Internet protocol (IP) address of user 102, order indicia such as an order number generated by merchant 104, and estimated shipping date provided to user 102 by the merchant 104. In one embodiment, this information is provided by merchant 104 to user 102 through the use of a conversion pixel embedded into the order confirmation page displayed by merchant 104 to user 102. The conversion pixel then causes the user's browser to convey the transaction information to customer transaction module 123, which stores the received information in customer order database 110. In some embodiments, additional information is also conveyed to the MTE 106 via conversion pixel or other reporting mechanism, including indicia of the product(s) ordered, price paid for the product, price paid for shipping, estimated ship weight, estimated delivery date, etc.

Merchants 104 provide shipment information to merchant transaction module 125, either in real time or in periodic batches. Since there is generally a delay between when a transaction is made and when a shipment is tendered to shipment carrier 108, the order information is typically received from user 102 hours, days, or weeks prior to the shipment information being received for that order from merchant 104. In one embodiment, shipment information received from merchant 104 includes an order number, shipment carrier identification, and shipper tracking number. In some embodiments, shipment information also includes delivery information such as a complete delivery address, shipping service level (such as ground or next-day air), or alternatively an approximate delivery location such as city and state, postal code, etc., and shipment weight. Merchant transaction module 125 stores the received shipment information in merchant database 114. In an alternative embodiment, the shipment information is received from shipment carrier 108 rather than merchant 104. In another embodiment, the shipment information is provided to the user 102, who in turn provides it to MTE 106, e.g., by forwarding an e-mail, or through a beacon in a notification e-mail sent from merchant 104 to customer 102.

Tracking numbers are identifiers generated by shipment carriers for each shipment handled by the carrier. Tracking numbers are typically provided by the carrier 108 to the sender of the shipment—in this case, the merchant, and merchants often forward tracking numbers to purchasers so that they can observe the progress of individual packages handled by shipment carrier 108. Automated shipment module 118 accesses tracking information provided by shipment carrier 108 to confirm shipment and arrival dates for shipments as described further below. In one embodiment, shipment carrier 108 provides an API or other mechanism through which shipment module 118 obtains the tracking information. In one embodiment, shipment carrier 108 provides periodic status reports for each tracking number of interest to merchant transaction module 125. Tracking numbers include details such as a package's actual date and time of shipment, its location while in transit, its actual date and time of delivery, the specific or approximate locations of the package's origin and destination, and the weight of the package. In one embodiment, after merchant transaction module 125 receives a tracking number from merchant 104, automated shipment module 118 begins querying shipment carrier 108 for shipment information associated with the tracking number. MTE 106 automatically collects data related to that tracking number from shipment carrier 108 and stores it in shipment carrier database 116. In one embodiment, shipment module 118 provides predicted shipment details to carrier 108 as part of the tracking inquiry, and carrier 108 returns a true or false response for each detail.

Once merchant transaction module 125 receives a set of tracking numbers and associated order numbers, evaluation engine 120 matches the order numbers with those stored in customer order database 110. Evaluation function module 120 scores merchants 104 based on a comparison of promised or estimated ship dates and actual outcomes. In one embodiment, merchants are evaluated with respect to when an order was tendered to the shipment carrier; in an alternative embodiment, evaluations are also based on when the order was delivered by the shipper to the destination address.

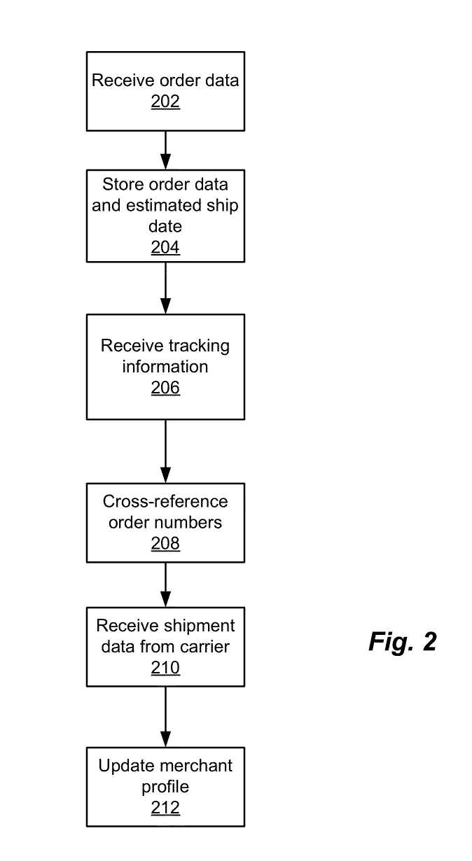

FIG. 2 illustrates a method for updating merchant profile data in accordance with one embodiment. Customer transaction module 123 receives 202 order data from user 102 upon completion of a transaction. As noted, the order data includes an order number or other indicia sufficient to uniquely identify the order, and includes at least one of an estimated ship date and estimated delivery date. Customer transaction module 123 then stores 204 the order data and shipment information in customer orders database 110. At some subsequent time, merchant transaction module 125 receives 206 an indication from merchant 104 (or, alternatively, carrier 108) indicating that the order has shipped. As noted, this may be in the form of a batch report of orders that have shipped since the past report, e.g., a daily shipping log. Automated shipment module 118 cross-references 208 the order number received from the merchant with the order numbers stored in customer order database 110 to identify the order that has been shipped. The indication includes the order number or other order-identifying indicia, as well as a tracking number or other indicia sufficient to identify the shipment with shipment carrier 108. Automated shipment module 118 then obtains 210 shipment data from carrier 108 using the tracking number received from merchant 104. Automated shipment module 118 may query shipment carrier 108 periodically, e.g., daily, weekly, etc., to determine when the shipment has been delivered. Once the shipment has been delivered, automated shipment module 118 updates 212 a merchant profile for the merchant 104 in merchant profile database 122 to reflect performance data for the order including the estimated and actual ship date and delivery date.

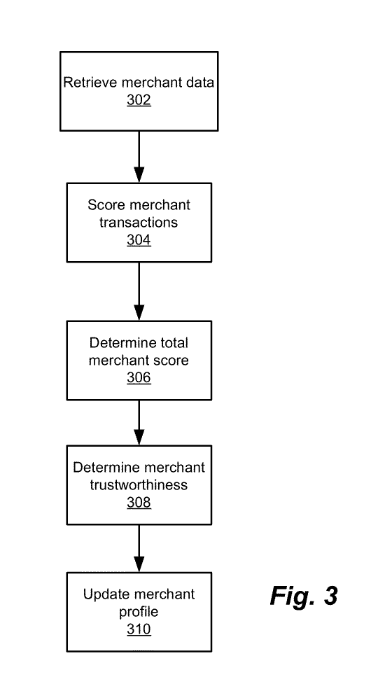

FIG. 3 illustrates a method for evaluating a merchant in accordance with one embodiment. As described above with respect to FIG. 2, shipment data is collected for each order fulfilled by the merchant 104, and the merchant's profile is updated to include performance data. To evaluate a merchant, evaluation engine 120 retrieves 302 merchant data from merchant profile database 122. The merchant data includes indicia of an estimated ship date and an actual ship date for each tracked order fulfilled by the merchant 104. In some embodiments, the merchant data also includes an estimated delivery date and an actual delivery date. Evaluation engine 120 then scores 304 each order according to a scoring function. In one embodiment, a merchant is awarded a score for meeting the ship date estimate, and receives no points for missing the deadline. In an alternative embodiment the scoring function awards a number of points to the merchant for tendering the shipment to the shipper on the estimated ship date, and decays the number of points awarded according to a decay function for each day of delay. In one embodiment, points are added to the baseline number for each day in advance of the promised ship date the merchant tendered the shipment. In embodiments where the merchant is evaluated based on delivery date to the customer, a similar scoring function is applied. In some embodiments, the score awarded based on tender date is weighted relative to the score awarded based on delivery date, to increase or decrease the significance of each measure according to the preference of the implementer.

Once each transaction is scored, the total merchant score is determined 306 by averaging across all transactions. In some embodiments, the score is further normalized to account for variations such as total number of orders processed. The total merchant score is then used to determine 308 the level of trustworthiness to be associated with the merchant. In one embodiment, any merchant who exceeds a threshold score—which may be set by the implementer—is determined to be trustworthy, while those merchants falling short of the score do not receive the trustworthy designation. In other embodiments, score bands are used to assign particular levels of trustworthiness to merchants. These bands may be, for example, percentiles, letter grades, qualifiers such as “good,” “very good,” “poor,” etc., or any other suitable label that quantitatively or qualitatively differentiates among scored merchants. The merchant profile is then updated 310 to reflect the assigned level of trustworthiness.

In one embodiment, the merchant profile also includes information about the merchant's overall shipping performance. For example, an average time-to-ship can be determined based on an average number of days the merchant takes between receiving the order and tendering it to the shipment carrier. An average time-in-transit or total-time-to-delivery can also be determined for the merchant, in the former case by finding an average time from tender to delivery, and in the latter case by finding an average time from order receipt to shipment delivery.

In one embodiment, MTE 106 incorporates a fraud detection analysis as part of the merchant evaluation process. For example, a merchant 104 may attempt to skew the results of the evaluation by placing a high volume of false orders and then immediately shipping empty or near-empty packages that correspond to the false order number to inflate its trustworthiness rating. In one embodiment, evaluation engine 120 reviews the shipment weight for each shipment obtained from shipment carrier 108. In one embodiment, shipments with a weight below a certain value are not considered in the evaluation process. In one embodiment, order information received from user 102 includes the shipping weight of the purchased product, e.g., in the conversion pixel, and evaluation engine 120 compares the shipping weight in the order information to the shipment weight obtained from the carrier to confirm the legitimacy of the order, ignoring transactions with mismatches greater than a particular amount or percentage, as may be specified by the implementer. In one embodiment, shipping weight can be estimated if the order information includes the product description, based on commercially available information regarding the shipping weight of commercial products, or using shipping weight for the same product shipped by one or more other merchants. In one embodiment, evaluation engine 120 compares the geographical location of the IP address associated with the user 102 who placed the order with the delivery postal code obtained from shipment carrier 108, and assigns a higher score to transactions where the two locations are within a threshold distance of each other. The threshold distance may be set at, for example 25 miles, or may be adjusted by the implementer. Obtaining a location based on an IP address can be performed using traditional methods of IP geolocation. In various embodiments, the weight assigned based on a particular fraud detection algorithm is adjustable. For example, merchants such as florists frequently deliver gifts to addresses other than the address of the customer placing the order, and an implementer may choose to reduce the weight of the IP-to-postal-code comparison performed for that class of merchants.

In one embodiment, evaluation engine updates the trustworthiness score of a merchant periodically, enabling a merchant 104 to reclaim trustworthy status that it may have lost, as well as removing that status from merchants with deteriorated performance metrics. In one embodiment, a merchant's score is decayed such that the merchant's recent performance, e.g., within the previous 90 days, has more influence on the score than does older performance.

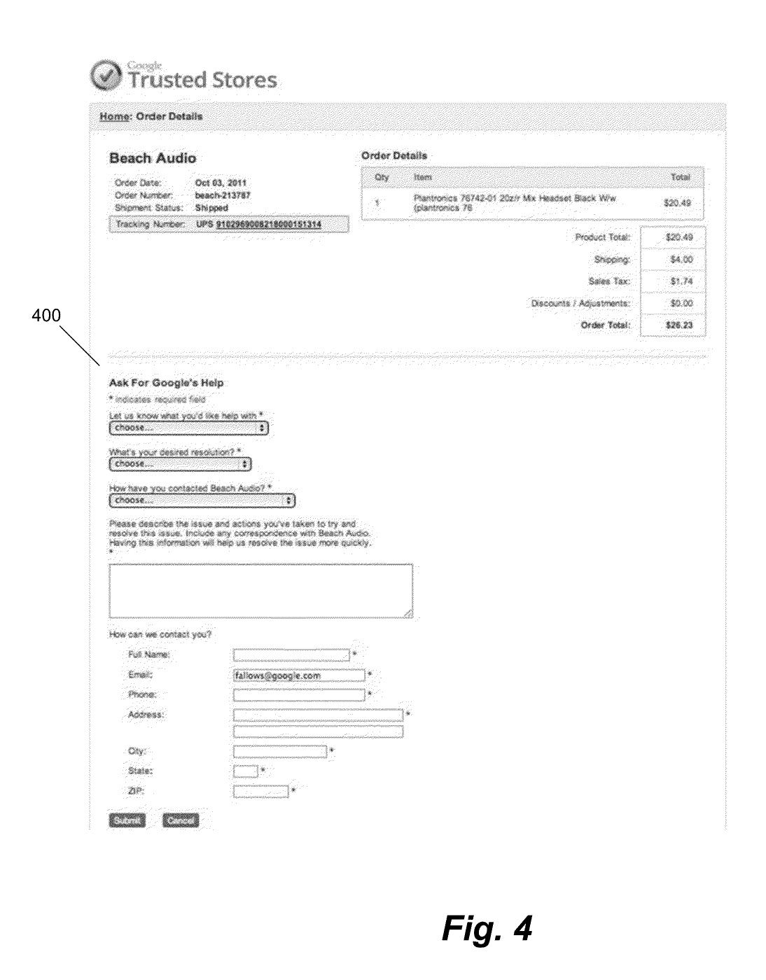

Some customers will inevitably encounter difficulties with their orders, regardless of who the merchant is. MTE 106 scores merchants on their ability to resolve customer complaints quickly and effectively. In various embodiments, a user 102 initiates a complaint process by, for example, selecting a link from an order confirmation e-mail or web page of MTE 106. For example, FIG. 4 illustrates a web page 400 accessed by user 102 for filing a complaint with MTE 106 about a merchant 104. Submitting the web page initiates a problem resolution monitoring action by MTE 106.

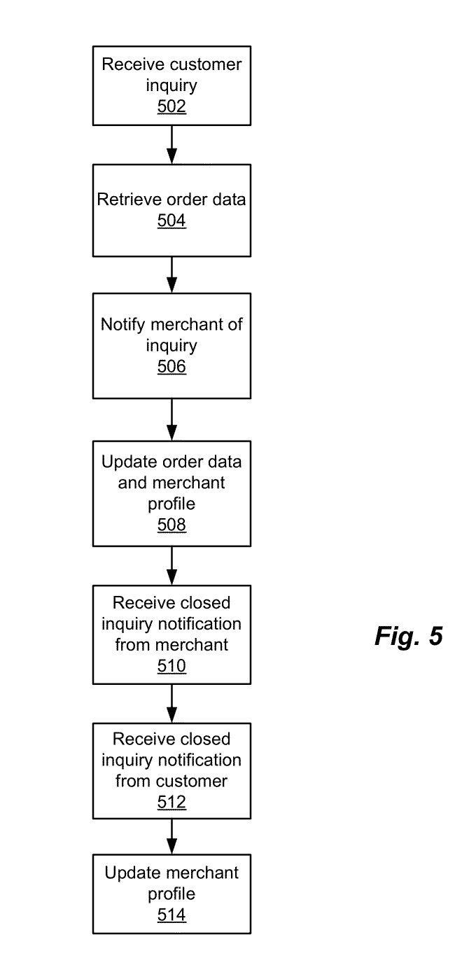

FIG. 5 is a flowchart illustrating a method for complaint tracking in accordance with one embodiment. Complaint tracking module 127 receives 502 the customer inquiry/complaint from user 102, and retrieves 504 the order data from customer order database 110 for the order to which the complaint applies. Complaint tracking module 127 then notifies 506 the merchant 104 about the inquiry, providing indicia to the merchant sufficient for the merchant to be able to identify the order in question. Complaint tracking module 127 also updates 508 the customer order data and the merchant's profile to reflect that an inquiry was placed with the merchant, and the time and date on which the inquiry was made. Merchant 104 addresses the complaint or inquiry and then notifies 510 complaint tracking module 127 that the issue has been addressed and should be closed. In one embodiment, to confirm the truthfulness of the merchant's assertion, complaint tracking module 127 contacts user 102, e.g., by e-mail, and verifies 512 that the user's issue has been addressed. If the user 102 contradicts the merchant's assertion, then in one embodiment the issue is escalated to a human reviewer to make a final determination. Assuming that the user does not contradict the merchant's assertion, or that the question is resolved in the merchant's favor by a reviewer, the merchant profile and customer order data are updated 514 to reflect the amount of time the merchant took to resolve the complaint.

Using historical complaint data obtained as described above, evaluation engine 120 determines, for a particular merchant 104, whether the merchant is more or less likely than other merchants to receive a complaint. This value can be expressed, for example, as a percentage. In addition, evaluation engine 120 determines from the merchant's profile an average time taken by the merchant to respond to complaints. This information allows MTE 106 to report, for example, that ABC Flowers receives complaints about 2% of its orders, and handles complaints in an average of 3 business days. Continuing the example, MTE 106 can also report that ABC Flowers performs in the top third compared to the number of complaints received by other florists, or by all merchants, and in the top half compared to time taken by average florists, or all merchants, to respond to complaints. In one embodiment, MTE 106 reports these findings as a score, e.g., an “A−”, or using a star system or other technique for reporting ratings. In one embodiment, merchants having a sufficiently high score (as determined by the implementer) for either or both of the complaint frequency and resolution time are determined to be trustworthy in these customer service categories.

In various embodiments, MTE 106 stores information about a merchant's product catalogue in merchant database 114. Products in the catalog may be further categorized according to type, e.g., electronics, books, music, furniture, etc. In one embodiment, MTE 106 receives product catalogue information directly from each merchant 104. In alternative embodiments, MTE 106 builds the catalogue by observing information about order contents when transactions are reported to MTE 106. In one embodiment, evaluation engine 120 scores each merchant 104 according to a number of items in a particular category of its product catalogue. Particular scores assigned may be left to the discretion of the implementer.

In various embodiments, MTE 106 also tracks information about merchants' return policies. For example, in one embodiment each merchant 104 completes a survey that indicates its policy with respect to policies of interest to the implementer, which may include number of days to return an item; who pays for return shipping; whether there is a restocking fee, and if so, how much the fee is; whether a return shipping label is included in the original shipment; whether the merchant requires a return authorization prior to the user returning an item, etc. MTE 106 stores return policy information in merchant profile database 122, and in one embodiment evaluation engine 120 compiles a return policy score for each merchant, with points awarded according to how the merchant responded to survey questions. The particular points awarded for different responses may be left to the implementer.

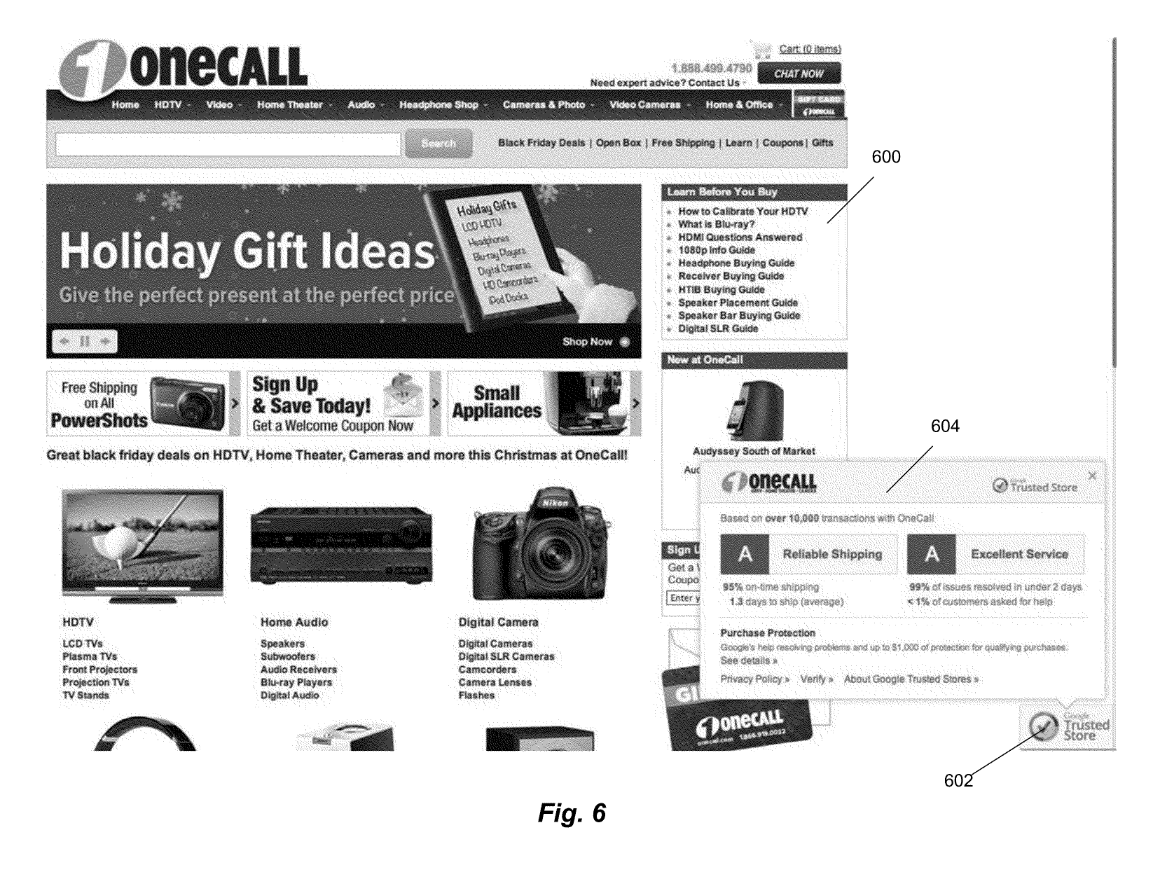

Once merchants have been assigned scores based on some or all of shipping performance, complaint resolution, product catalogue, and return policy, information about the scores can be conveyed to consumers as part of the shopping experience. For example, a merchant 104 that has obtained a score from MTE 106 may display (or have displayed on its behalf by MTE 106) indicia of the score—such as the score itself, or a rating associated with the score—on its web site. FIG. 6 illustrates a merchant web site 600 that includes a badge 602 indicating that the merchant is a “Trusted Store”. In the illustrated example, hovering over the badge causes a popup window 604 to open indicating that in this case, the merchant has an “A” rating for both “Reliable Shipping” and “Excellent Service”. In particular, in this example the merchant shipped orders on time in 95% of tracked cases, with an average time of 1.3 days to ship. Ninety-nine percent of customer service issues were resolved in under 2 days, and fewer than 1% of customers filed a complaint.

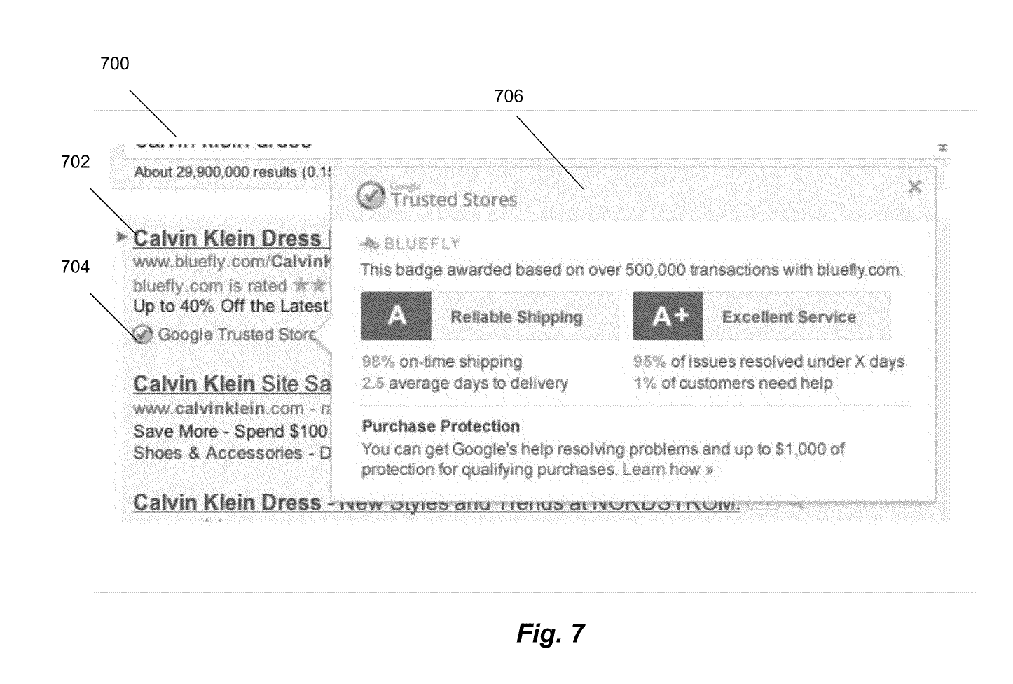

In another embodiment, these performance metrics may be displayed in conjunction with search results on a web page. For example, FIG. 7 illustrates an excerpt from a page 700 of search results. The first result 702 includes a badge 704 and an indication that the store is a “Trusted Store”. Hovering over the indication causes a popup window 706 to be created showing the determined scores for the merchant.

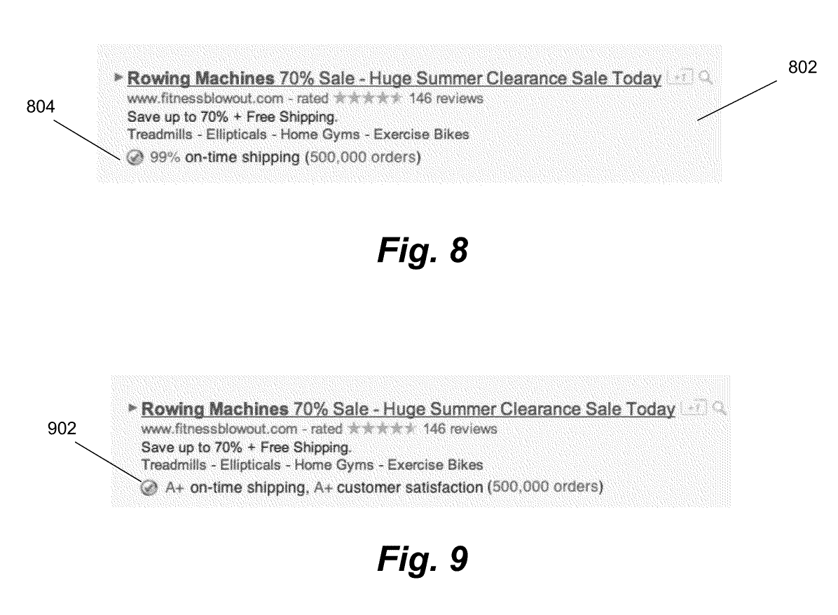

In an alternative embodiment, as indicated in FIG. 8, a search result or advertisement 802 may include a badge 804 indicating that the store is a trusted merchant, and that in the illustrated case, the merchant has a score of 99% for on-time shipping, based on 500,000 orders.

In one embodiment, hovering over the score or badge causes a popup such as popup window 706 to be created.

FIG. 9 illustrates an alternative embodiment including a badge 902 and indication that the merchant has an A+ rating for on-time shipping and an A+ for customer service, based on 500,000 orders.

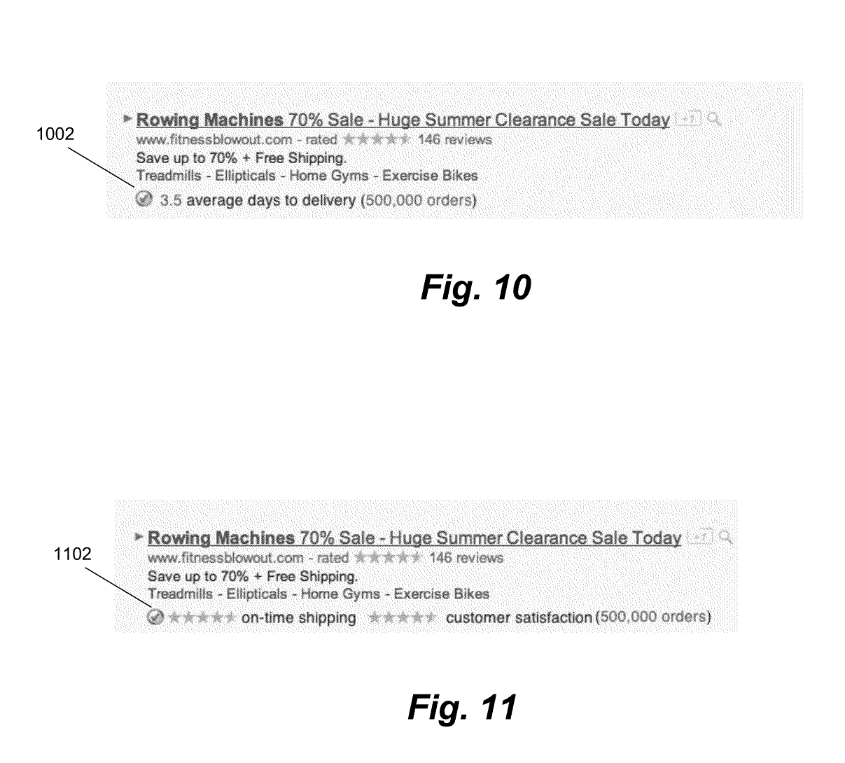

FIG. 10 illustrates an embodiment including a badge 1002 and an indication that the merchant has achieved an average time to delivery of 3.5 days, based on 500,000 orders.

FIG. 11 illustrates an embodiment including a badge 1102 and an indication that the merchant has received 4.5 stars out of 5 for on-time shipping, and 4.5 stars out of 5 for customer satisfaction based on an analysis of 500,000 orders.

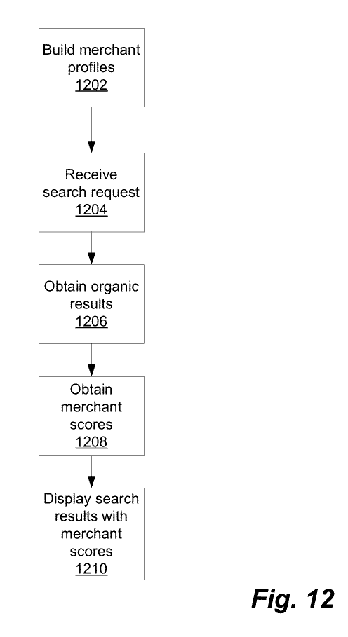

Thus, a merchant can notify potential customers of its scores as indicated above either through its own web page, through ads placed on other web sites such as search engine sites, or in association with organic search engine results that are returned in conjunction with a web search using a search engine. For example, a method for displaying search results is illustrated in FIG. 12. MTE 106 builds 1202 merchant profiles as described above, and stores the profiles in merchant profile database 122. A search engine, is operated in association with or in communication with MTE 106 receives 1204 a search request from a user. The search engine executes the search request and obtains 1206 a list of organic search results matching the search query and, in some embodiments, advertising creatives to be served along with the results. The search engine then obtains 1208, e.g., by request from MTE 106, scores for each advertised merchant that has a merchant score, and in various embodiments also retrieves merchant scores for those merchants appearing in the organic search results. The search results and advertisements are then displayed 1210 along with badges or other indicia as described above. In some embodiments, merchants having a score are displayed before those having no score, and merchants having higher scores are listed before merchants having lower scores.

In the context of a shopping aggregation site, which displays a list of merchants from whom a particular product is available, the site can indicate next to some or all merchants what score or rating has been assigned by MTE 106 to those merchants. In some embodiments, MTE 106 may itself be the online shopping aggregation site. In alternative embodiments, MTE 106 makes scores or ratings available to merchants, online shopping aggregation sites, search engines, and/or the public at large, and in some embodiments does so for free, and in alternative embodiments does so for a fee. In some embodiments, merchants display indicia of their score through media other than the Internet—for example, via television and radio commercials, in-store displays, and newspaper advertisements.

The present invention has been described in particular detail with respect to a limited number of embodiments. Those of skill in the art will appreciate that the invention may additionally be practiced in other embodiments.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component. For example, the particular functions of automated shipment module 118, evaluation engine 120, and so forth may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “collecting” or “evaluating” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for scoring merchant performance, the method comprising:
for each of a plurality of transactions, each transaction between a merchant and one of a plurality of customers:
receiving customer order data, the customer order data including an order identifier;
receiving from the customer complaint information about the identified order;
transmitting to the merchant at a first time the complaint information and the order identifier;
receiving from the merchant an indication that the complaint was resolved at a second time;
receiving a confirmation from the customer that the complaint was resolved at the second time;
scoring each merchant according to an amount of time between the first time and the second time for each of the plurality of transactions including the merchant; and
storing classification indicia for each merchant, the classification determined according to the merchant's score.

2. The method of claim 1 wherein customer order data is received from the customer.

3. The method of claim 2 wherein the customer order data is received via a conversion pixel.

4. The method of claim 1 wherein customer order data includes an IP address associated with the customer.

5. The method of claim 1 wherein storing classification indicia for the merchant further comprises:
responsive to the merchant's score exceeding a threshold score, classifying the merchant according to a first classification.

6. The method of claim 5 wherein storing classification indicia for the merchant further comprises:
responsive to the merchant's score not exceeding a threshold score, classifying the merchant according to a second classification.

7. The method of claim 1 further comprising:
receiving a request for a merchant's classification;
retrieving the stored classification indicia associated with the merchant; and
providing the retrieved indicia in response to the request.

8. A computer program product for displaying merchant performance, the computer program product stored on a non-transitory computer-readable medium and including instructions configured when loaded into memory to cause a processor to perform steps comprising:
for each of a plurality of transactions, each transaction between a merchant and one of a plurality of customers:
receiving customer order data, the customer order data including an order identifier and an estimated ship date;
receiving merchant data, the merchant data including the order identifier and shipment information;
determining using the shipment information an actual ship date;
determining a difference between the estimated ship date and the actual ship date;
determining for each merchant an on-time shipment frequency by determining, for each shipment involving the merchant, a frequency with which the estimated ship date and the actual ship date are the same date; and
displaying in response to a request for product information about a product offered by a plurality of the merchants, identifiers for each of the merchants offering the product and the on-time shipment frequency determined for each merchant.
